(19) United States
(12) Patent Application Publication
(10) Pub. No.: US 2011/0316962 A1
(43) Pub. Date: Dec. 29, 2011

(54) BIDIRECTIONAL COMMUNICATION INTERFACE APPARATUS, BIDIRECTIONAL COMMUNICATION INTERFACE SYSTEM AND SIGNAL TRANSMISSION METHOD

(75) Inventors: Takashi Doi, Fuchu-shi (JP); Masahiko Mawatari, Yokohama-shi (JP); Kazuhiko Taira, Fukaya-shi (JP)

(73) Assignee: KABUSHIKI KAISHA TOSHIBA, Tokyo (JP)

(21) Appl. No.: 13/152,799

(22) Filed: Jun. 3, 2011

(30) Foreign Application Priority Data
Jun. 29, 2010 (JP) 2010-148124

(51) Int. Cl. H04N 7/14

(52) U.S. Cl. 348/14.01; 348/E07.077

(57) ABSTRACT

According to one embodiment, a bidirectional communication interface apparatus including, a first converting module configured to convert a mixed output of a video signal and audio signal from a source device to an optical signal, an optical cable configured to transmit the optical signal converted by the first converting module, and a second converting module configured to convert the optical signal transmitted via the optical cable to a mixed output of a video signal and audio signal and input a result of conversion to a sink device.

### CROSS-REFERENCE TO RELATED APPLICATIONS

This application is based upon and claims the benefit of priority from Japanese Patent Application No. 2010-148124, filed Jun. 29, 2010, the entire contents of which are incorporated herein by reference.

### FIELD

Embodiments described herein relate generally to a bidirectional communication interface apparatus.

### BACKGROUND

As a bidirectional communication interface apparatus, the High-definition Digital Media Interface (HDMI) is widely used.

In HDMI itself, Audio Return Channel version 1.4 (ARC)/HDMI Ethernet Channel version 1.4 (HEC) or the like is defined following the Consumer Electronics Control (CEC) standard defined later.

In HDMI version 1.4, high-speed Ethernet (registered trademark) communication is realized for a video signal and audio signal, but it is required to further enhance the transmission speed. Further, it becomes possible to transmit input of an audio output from a sink device to a source device by means of a single HDMI cable based on ARC (version 1.4), but an optical digital audio output of the sink device cannot be directly output to the source device.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram showing an example of a system configuration according to an embodiment;

FIG. 2 is an exemplary diagram showing an example of a system configuration according to an embodiment;

FIG. 3A is an exemplary diagram showing an example of a configuration on the transmission side according to an embodiment;

FIG. 3B is an exemplary diagram showing an example of a configuration on the reception side according to an embodiment;

FIG. 4 is an exemplary diagram showing an example of a system configuration according to an embodiment;

FIG. 5 is an exemplary diagrams each showing an example of receptor and plug configurations according to an embodiment;

FIG. 6 is an exemplary diagram showing an example of a configuration on the transmission side according to an embodiment; and

FIG. 7 is an exemplary diagram showing an example of a configuration on the reception side according to an embodiment.

### DETAILED DESCRIPTION

Various embodiments will be described hereinafter with reference to the accompanying drawings. In general, according to one embodiment, a bidirectional communication interface apparatus comprising: a first converting module configured to convert a mixed output of a video signal and audio signal from a source device to an optical signal; an optical cable configured to transmit the optical signal converted by the first converting module; and a second converting module configured to convert the optical signal transmitted via the optical cable to a mixed output of a video signal and audio signal and input a result of conversion to a sink device.

Embodiments will now be described hereinafter in detail with reference to the accompanying drawings.

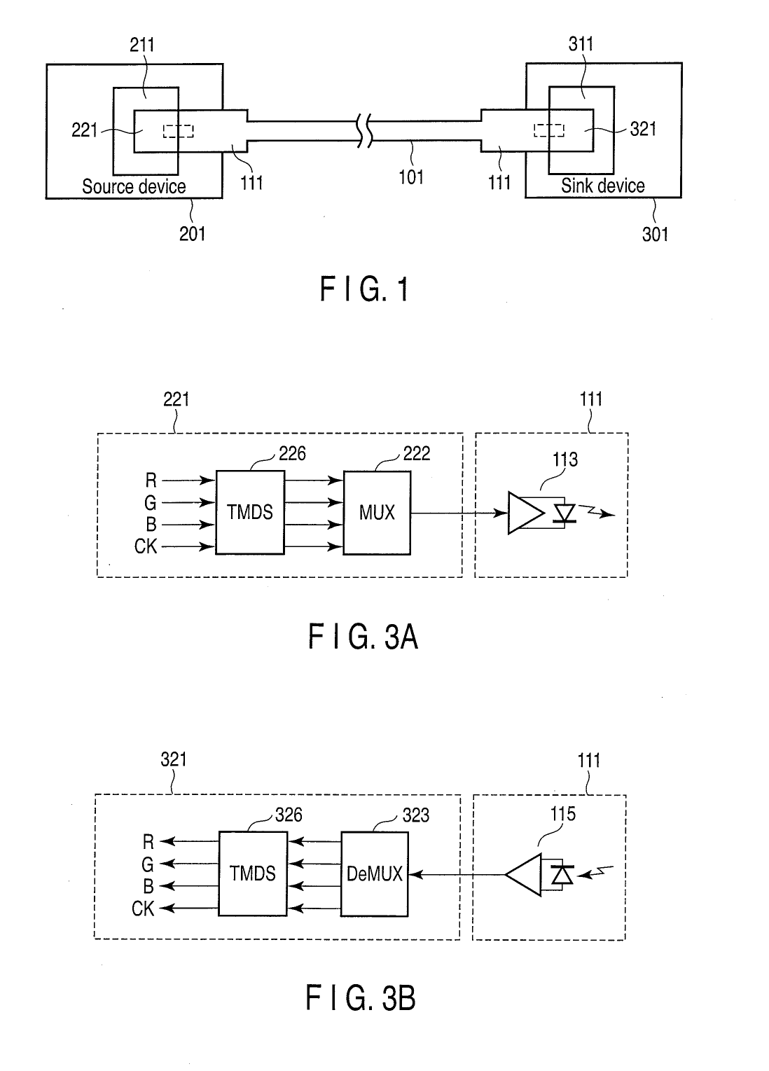

FIG. 1 shows an example of a recording/playback apparatus to which an embodiment is applied and a video image display apparatus connected to the recording/playback apparatus. Respective elements and configurations described below may be realized by means of hardware or software executed by a microcomputer (processing apparatus, CPU) or the like. Elements/components described to as “module” below may be obtained by hardware or may be obtained by software using, for example, a microcomputer (processor, CPU), etc.

A bidirectional communication interface, for example, a High-definition Digital Media Interface (HDMI) 101 includes an optical transmission cable 121 that is an optical fiber, for example, between plugs (plug, cable-side connector) 111 on both end portions thereof. The HDMI 101 can support the version 1.4 (ARC/HEC) and transmit an optical digital audio signal.

A recording/playback apparatus 201 that plays back content, that is, programs or TV programs, is connected to one of the plugs 111 of the HDMI 101 and a video image display apparatus (monitor apparatus, display or television receiver) 301 is connected to the other plug 111 thereof. The recording/playback apparatus 201 is referred to as a source device. The video image display apparatus 301 is referred to as a sink device with respect to the source device (recording/playback apparatus 201).

The source device (recording/playback apparatus) 201 may be a recorder device that records and plays back a video signal and audio signal of content, that is, a TV program or program, a player device that can only play back content, a game device, a video camera or the like. Further, the source device 201 may be a personal computer (PC), a data playback apparatus (optical disk drive apparatus) that can be connected to a PC and play back data (content) held by an optical disk of, for example, the DVD standard/CD standard or the like, a reader/writer (data playback apparatus) that can read data (content) from a solid-state drive (SSD [semiconductor memory device]), for example, a mobile terminal device, digital camera device or mobile telephone device or a navigation device that can be mounted in a car or which the user can carry.

The source device 201 includes an HDMI interface module 211 connected to one of the plugs 111 of the HDMI 101. The interface module 211 includes a receptor (receptacle, device-side connector) 221 to which the plug 111 of the HDMI 101 can be connected.

The sink device 301 includes an HDMI interface module 311 connected to the other plug 111 of the HDMI 101. The interface module 311 includes a receptor (device-side connector) 321 to which the other plug of the HDMI 101 can be connected.

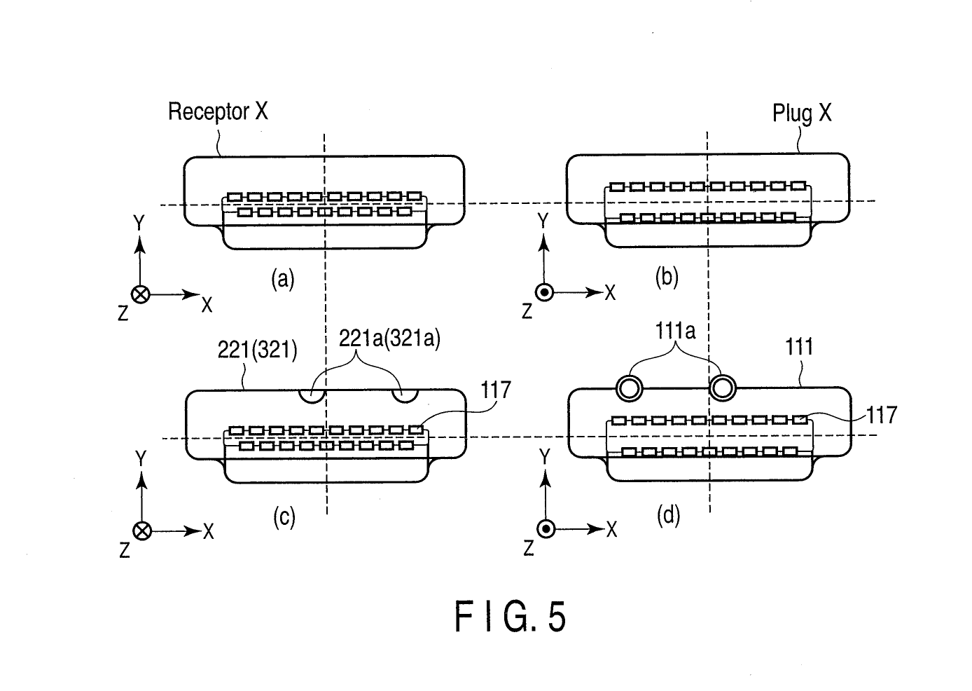

The plug 111 of the HDMI 101 will be explained later with reference to FIG. 5. The plug has a shape that cannot be connected to a conventional type receptor (hereinafter referred to as receptor X) that supports the version 1.4 (the plug cannot be inserted into the receptor X). The type of HDMI 101 in which a function is added to the version 1.4 can be clearly shown based on the feature of the shape thereof by forming the shape of the plug 111 that cannot be connected to the receptor X. Therefore, the HDMI 101 can be prevented from being erroneously connected to a source device or sink device having the receptor X based on the feature of the shape.

The feature of the shape of the plug 111 can be achieved by means of convex portions corresponding to concave portions formed in the receptor 221 (source device-side interface module 211) and receptor 321 (sink device-side interface module 311). The convex portions of the plugs 111 can be easily detected by means of switches that are turned on by pressure from the convex portions (of the plugs) or mechanisms (photointerrupters or the like) that detect the presence of the convex portions in the concave portions of the receptors 221 and 321, for example.

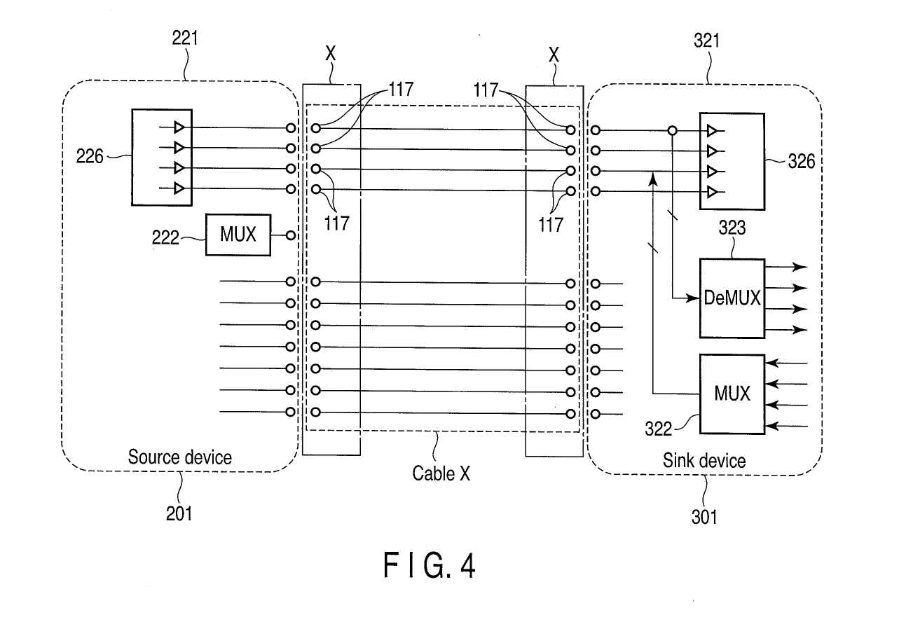

The receptor 221 (source device 201) and receptor 321 (sink device 301) will be explained later with reference to FIG. 4 and FIG. 5, but a plug (hereinafter referred to as plug X) conforming to the version 1.4 can be mounted on the receptor. Based on the feature of the shape, a connection can be made by use of an HDMI cable of the version 1.4 that includes a plug X and compatibility of the connection between the source device and the sink device can be achieved in the range of the version 1.4.

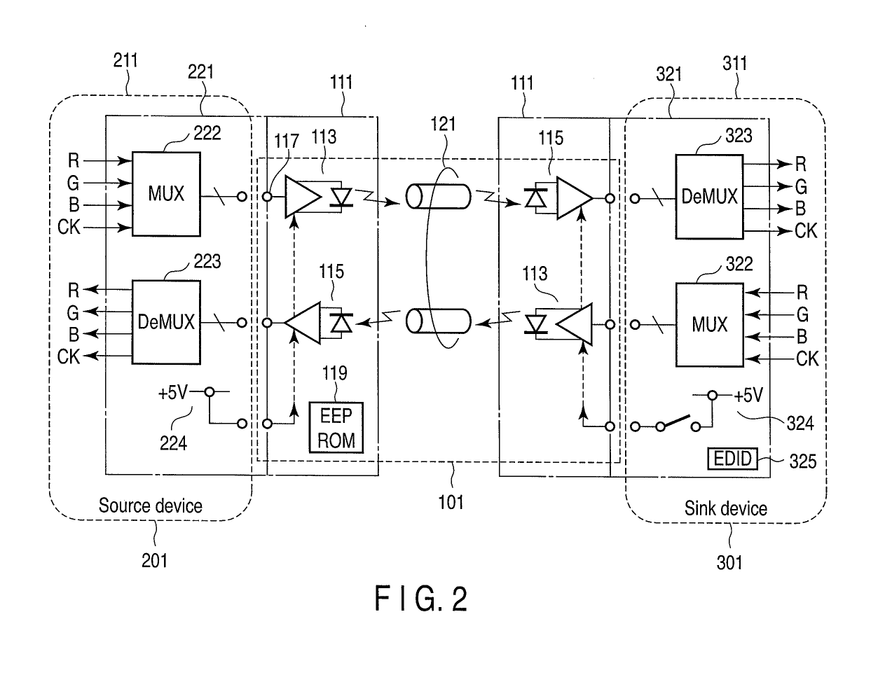

FIG. 2 shows the configuration of the HDMI 101 and signal transfer thereof.

FIG. 2 shows a state in which the receptor 221 of the interface module 211 of the source device 201 and the receptor 321 of the interface module 311 of the sink device 301 are connected via the HDMI 101.

The receptor 221 on the source device 201 side includes a multiplexer (MUX) 222 having four transition-minimized differential signaling (TMDS) channels configured by red (R), green (G), blue (B) and clock (CK) and coexisting in one channel, a demultiplexer (DeMUX module) 223 that separates signals coexisting in one channel into four TMDS channels and a power source (5 V line) 224.

The receptor 321 on the sink device 301 side includes a multiplexer (MUX module) 322 having four TMDS channels coexisting in one channel (like the source-side receptor 221), a demultiplexer (DeMUX module) 323 that separates signals coexisting in one channel into four TMDS channels and a power source (5 V line) 324. Further, the receptor 321 on the sink device 301 side is equivalent to the version 1.4 in that it includes extended display identification data (EDID) 325 used to determine the performance (playback ability) of the sink device on the source device side. The EDID 325 is capability data (for example, the receivable timing of the TV receiver is up to 1080p) of the sink device (TV receiver) 301 and can be acquired by the source device 201 according to a read command from the source device 201.

The plug 111 (which may be referred to as plug Y to distinguish it from a plug corresponding to the version 1.4) at one end of the HDMI 101 includes an optical signal generator 113 that converts an output from the MUX (multiplexer) of a receptor (receptor Y) of the to-be-connected source device 201 (or the sink device 301), a photoelectric converter 115 that converts an optical signal transmitted from the other plug 111 via the optical fiber 121, a terminal (contact) 117 that is applied with a voltage of 5 V from the power source (224) of the receptor Y of the source device and the like. Since an EEPROM 119 that holds an identifier 101a indicating a type and a version corresponding to the HDMI 101 is incorporated in one of the plugs 111, the version can be distinguished from the (conventional) version 1.4 at the time of signal transmission that will be explained later.

The optical signal generator (photoelectric converter) 113 includes a photoelectric converter, for example, a laser diode, subjects an output of the receptor (receptor Y) of the source device 201 (or the sink device 301) that is a transmission source to photoelectric conversion and inputs the result of conversion to the optical fiber 121.

The photoelectric converter 115 converts an optical signal transmitted from the optical fiber 121 via the sink device 301 (or the source device 201) that is a to-be-connected object to an electrical signal and inputs the result of conversion to the demultiplexer (DeMUX module) in the receptor.

In FIG. 2, a transmission output of the source device 201 obtained by mixing the signals in the MUX 222 is guided to one of the plugs 111 via the terminal 117, converted to a modulated optical output by the optical signal generator (photoelectric converter) 113 and input to the optical fiber 121.

An optical modulation output guided to the other plug 111 via the optical fiber 121 is converted to an electrical signal by means of the photoelectric converter 115 and output to the DeMUX module 323 of the sink device 301 via the terminal 117.

A transmission output of the sink device 301 obtained by mixing the signals in the MUX 322 is guided to one of the plugs 111 on the sink device 301 side via the terminal 117, converted to a modulated optical output by the optical signal generator 113 and input to the optical fiber 121.

An optical modulation output guided to the plug 111 on the source device 201 side via the optical fiber 121 is converted to an electrical signal by means of the photoelectric converter 115 and output to the DeMUX module 223 of the source 201 via the terminal 117.

More specifically, as shown in FIG. 3A, signals input to the MUX module 222 are video signals R, G and B and clock signal CK, and the respective signals are converted from 8 bits to 10 bits by means of the TMDS module (TMDS processor) 226 and output to corresponding channels of the TMDS module 226. Outputs of the respective channels of the TMDS module 226 are input to the MUX 222 and mixed as one channel output based on time division multiplexing.

The mixed signal is converted from an electrical signal to an optical signal by means of the photoelectric converter (optical signal generator) 113 and transmitted via the optical cable (121) or the like.

As shown in FIG. 3B, a signal input to the DeMUX module 323 is subjected to a process that is an inverse process shown in FIG. 3A. That is, an optical signal transmitted via the optical cable (121) or the like is converted to an electrical signal by means of the photoelectric converter 115 and the thus converted electrical signal is separated to respective TMDS channels by means of the DeMUX module 323. The signals of the respective TMDS channels separated by means of the DeMUX module 323 are converted from 10 bits to 8 bits in the TMDS module (TMDS processor) 326 and output signals of video signals R, G and B and clock signal CK can be obtained.

The receptor Y shown in FIG. 2 can also transmit a signal via the plug X that supports the version 1.4.

As shown in FIG. 5, the plug X can be connected to the receptor Y. If the plug X is inserted, the receptor 221 of the interface module 211 of the source device 201 and the receptor 321 of the interface module 311 of the sink device 301 cannot detect the convex portion prepared only for the plug 111, and therefore, they can detect that the plug is the plug X by use of a signal level corresponding to the version 1.4 and output to the terminal (contact) inherent to the plug X.

As shown in FIG. 4, when the plug X that supports the version 1.4 is connected to the receptor Y (221) of the source device 201 side, the video signals R, G and B and clock signal CK that are outputs of the respective channels of the TMDS processor 226 are transmitted to the receptor Y (321) on the sink device 301 side via a cable line (hereinafter referred to as cable X to distinguish it from the optical fiber 121) connected to the terminal 117 without passing through the MUX 222. The other signals (control signal, power source voltage, ground voltage and the like) are also supplied to the sink device 301 side via the cable line X.

When the plug X (the version 1.4) is connected to the receptor Y (321) on the sink device 301 side, the video signals R, G and B and clock signal CK that are outputs of the respective channels of the TMDS processor 326 are transmitted to the receptor Y (221) on the source device 201 side via the cable line X connected to the terminal 117 without passing through the MUX 322. The other signals (control signal, power source voltage, ground voltage and the like) are also supplied to the source device 201 side via the cable line X connected to the terminal 117.

In this case, the signal that can be transmitted via the cable line X is an electrical signal, but compatibility of the connection between the source device and the sink device can be achieved in the range of the version 1.4.

FIG. 5 shows the features of the shapes of the plug 111 of the HDM 101, the plug corresponding to the version 1.4 and the receptors Y corresponding thereto.

In FIG. 5, the type-X connector (corresponding to the version 1.4, receptor X) is shown as [a], the type-X connector (corresponding to the version 1.4, plug X) is shown as [b], the type-Y connector (receptor 221 [321]) is shown as [c] and the type-Y connector (plug 111) is shown as [d]. Further, the left side indicates the receptor (reception side) and the right side indicates the plug (insertion side).

As is clearly seen from FIG. 5, the whole shape of the contact of the type-Y connector ([c]/[d]) is the same as that of the type-X connector the version 1.4 ([a]/[b])).

The plug 111 ([d]) that is the type-Y connector has a protruding (convex) portion 111a in the connecting portion (part of the contact portion) or the surrounding mold (resin) portion to prevent it from being engaged with the receptor X of the type-X connector.

The receptor 221 or 321 ([c]) that is the type-Y connector has a shape (concave portion) 221a (321a) that receives the protruding portion 111a of the plug 111 of the type-Y connector, the shape thereof coincides with that of the plug and the receptor is engaged with the protruding portion 111a of the plug 111. The type-X plug having no protrusion on the plug side can also be similarly engaged as described above. Further, the presence of the protruding portion (convex portion) 111a of the plug 111 can be detected by means of a switch that is turned on by pressure by the convex portion (of the plug) or a mechanism (photointerrupter or the like) that detects the presence of the convex portion. When the plug of the type-X connector having no protruding portion 111a is connected, a signal can be transferred in accordance with the HDMI cable conforming to the version 1.4. If the plug can be detected to conform with the version 1.4, for example, power saving can be attained by stopping application of a power source voltage (5 V) to the photoelectric converter 115 and the photoelectric converter (optical signal generator) 113 of type Y (above HDMI 101). Further, power saving can be attained for the type-X connector that supports the version 1.4 by use of the type-Y connector and the number of connectors prepared for the product can be reduced. As a result, power saving for the connector and the like can be realized.

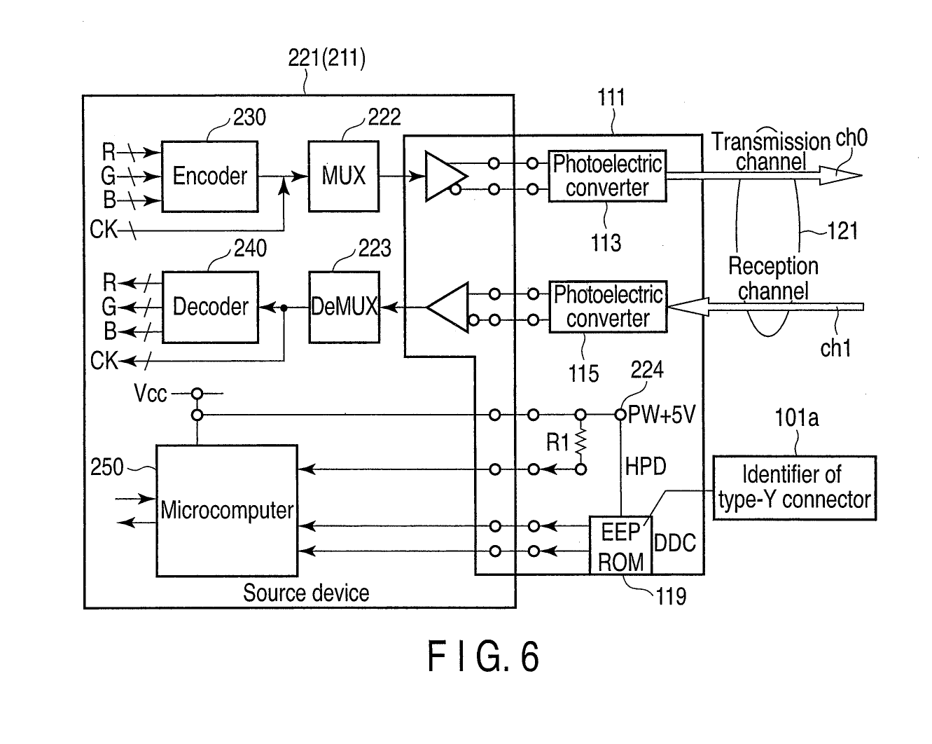

FIG. 6 shows an example of a detection method for detecting that a type-Y cable with type Y connector that is a cable configured to permit signal transmission by use of an optical digital signal in addition to signal transmission via the HDMI 101, that is, signal transmission corresponding to the version 1.4 is connected to the source device side.

In FIG. 6, in a transmission signal generated by the source device (201 in FIG. 1), video signals encoded by an encoder 230 that encodes the respective signals of video signals R, G and B are mixed with a clock signal CK by means of the MUX module (multiplexer) 222 and the mixed electrical signal is converted to an optical signal by means of the photoelectric converter 113 and transmitted to the sink device via the HDMI 101 (optical fiber 121) used as a transmission channel Ch₀.

A reception signal received from the sink device is input to the photoelectric converter 115 via the HDMI 101 used as a reception channel Ch₁ and converted to an electrical signal. The reception signal converted to the electrical signal by the photoelectric converter 115 is separated into a clock signal CK and video signals (which are encoded on the sink device side) by means of the DeMUX module (demultiplexer) 223. The separated video signals are decoded by a decoder 240 and stored, for example, in a buffer memory as video signals R, G and B.

At the time of signal transmission, it is confirmed that the HDMI 101 includes the optical cable 121 according to the presence or absence of the identifier 101a. The presence or absence of the identifier 101a can be confirmed by detecting that an EEPROM 119 is prepared by hot-plug detect (HPD) (detection of the sink device connection) when a power source voltage (5 V) is applied to the plug 111 (of the HDMI 101) in the receptor 221 of the interface module 211 of the source device 201, acquiring the identifier 101a held in the EEPROM 119 via a signal line display data channel (DDC) and determining the acquired identifier 101a by means of a microcomputer 250.

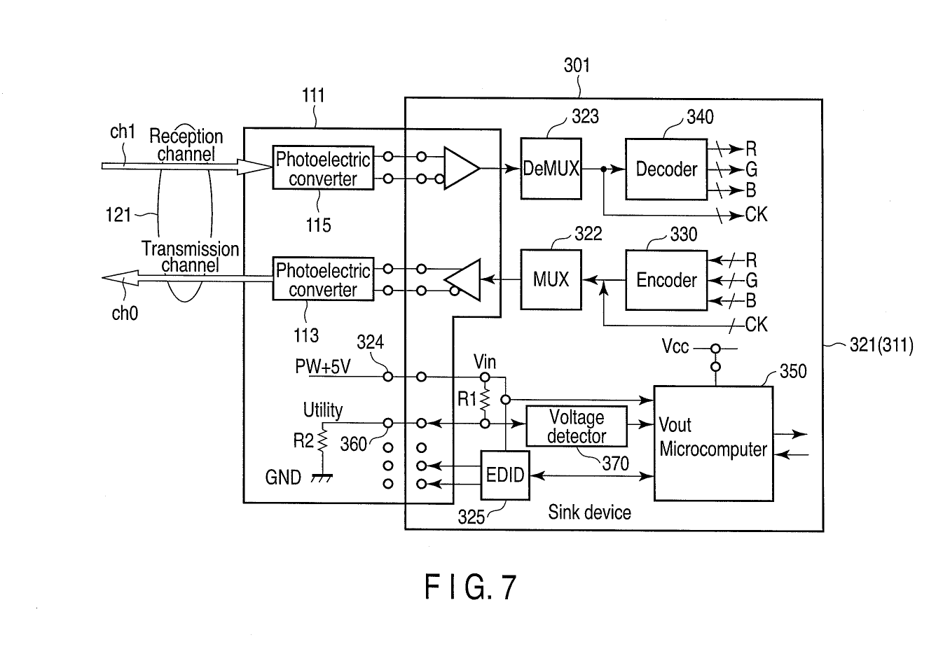

FIG. 7 shows an example of a detection method for detecting that a type-Y cable with type Y connector that is a cable configured to permit signal transmission by use of an optical digital signal in addition to signal transmission via the HDMI 101, that is, signal transmission corresponding to the version 1.4 is connected to the sink device side.

In FIG. 7, video signals R, G and B transmitted from the sink device (301 in FIG. 1) are encoded by an encoder 330, mixed with a clock signal CK by means of the MUX module 322 and then converted to an optical signal by means of the photoelectric converter (optical signal generator) 113. The transmission signal converted to the optical signal is transmitted to the source device via the HDMI 101 (optical fiber 121) used as the transmission channel Ch₁.

A signal from the source device that is received as the reception channel Ch₀ via the HDMI 101 is converted to an electrical signal by means of the photoelectric converter 113 and separated into a clock signal CK and video signals (encoded in the source device) by means of the DeMUX module 323 and the video signals are decoded to video signals R, G and B in a decoder 340 and stored in a buffer memory, for example.

At the time of signal transmission, it is confirmed that the HDMI 101 includes the optical cable 121 by determining a terminal voltage of a utility terminal 360 prepared for the receptor 321 of the interface module 311 of the sink device 301 by means of a microcomputer 350.

As one example, when the type-Y connector is connected by connecting the utility terminal 360 to ground (GND) via a resistor R2 and connecting the power source (5 V) to the utility terminal 360 via a resistor R1, the following voltage dividing equation is set up (Vout can be obtained).

Vout=(R2/(R1+R2))×Vin

where Vin=5 V and
Vout=Vutl (voltage of utility line).

For example, if Vin=5 V, R1=1 kΩ and R2=2 kΩ, then the relationship of Vout=Vutl=3.3 V can be obtained. Further, if a preset specified range is set to 3.0 to 4.0 V, it can be determined that the type-Y connector is connected. As Vutl (voltage of utility line), voltage Vutl of a utility line detected by a voltage detector 370 may be input to the microcomputer 350 in the receptor 321 of the interface module 311 of the sink device.

That is, when the power source voltage (5 V) is detected to be changed to a voltage in a preset specified range and the detected voltage is a voltage in the specified range, it can be confirmed that the HDMI 101 includes the optical cable 121.

As described above, the HDMI system that transmits a video signal, audio signal and control signal by use of the HDMI interface having the HDMI connector of the embodiment can transmit the optical digital signal. Further, when the connector (cable) conforming with the version 1.4 (type X) is mounted thereon, signal transmission in accordance with the conventional version (the version 1.4) can be performed. As a result, the number of types of connectors can be reduced, the cost of the components can be reduced and the terminal panel area can be effectively utilized.

Further, the HDMI system that transmits a video signal, audio signal and control signal by use of the HDMI interface having the HDMI connector of the embodiment can determine the type of a connected HDMI connector (cable) and use a transmission method suitable for the version of the HDMI, that is, the cable characteristic. Therefore, compatibility with respect to the existing HDMI device can be attained and the transmission speed of data utilizing an optical digital signal can be increased.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A bidirectional communication interface apparatus comprising:
a first converter configured to convert a first mixed output from a first source device to an optical signal, the mixed output comprising a video signal and an audio signal;
an optical cable configured to transmit the optical signal; and
a second converter configured to convert the optical signal transmitted via the optical cable to a second mixed output comprising a video signal and an audio signal, and to input a result of conversion to a first sink device.

2. The apparatus of claim 1, wherein the first converter comprises a plug configured to allow for connection to a first receptor of the first source device and to prevent connection to a second receptor of a second source device that is incompatible with the first receptor of the first source device.

3. The apparatus of claim 2, wherein the second converter comprises a plug configured to allow for connection to a first receptor of the first sink device and to prevent connection to a second receptor of a second sink device that is incompatible with the first receptor of the first sink device.

4. A bidirectional communication interface system comprising:
a source device configured to output a first mixed signal comprising a video signal and an audio signal;
a bidirectional communication interface apparatus comprising
a first converter configured to convert the first mixed signal from the source device to an optical signal,
an optical cable configured to transmit the optical signal, and
a second converter configured to convert the optical signal transmitted via the optical cable to a second mixed signal comprising a video signal and an audio signal; and
a sink device configured to separate the second mixed signal from the second converter into a separate video signal and audio signal.

5. The system of claim 4, wherein
the source device comprises a source receptor and the first converter comprises a first plug, and
the source receptor is configured to allow for connection to either the first plug or another plug having a different shape than the first plug.

6. The system of claim 4, wherein
the sink device comprises a sink receptor and the second converter comprises a second plug, and
the sink receptor is configured to allow for connection to either the second plug or another plug having a different shape than the second plug.

7. The system of claim 4, wherein
the first converter comprises a first plug and the source device comprises a source receptor, and
the source device is further configured to detect that the first plug is connected to the source receptor by referring to an identifier stored in a storage module associated with the first converter.

8. The system of claim 5, wherein the source device is further configured to detect that the first plug is connected to the source receptor by referring to an identifier stored in a storage module associated with the first converter.

9. The system of claim 4, wherein
the second converter comprises a second plug and the sink device comprises a sink receptor, and
the sink device is further configured to detect that the second plug is connected to the sink receptor based on a magnitude of a terminal voltage of a preset terminal associated with the second converter.

10. The system of claim 6, wherein the sink device is further configured to detect that the second plug is connected to the sink receptor based on a magnitude of a terminal voltage of a preset terminal associated with the second converter.

11. A signal transmission method comprising:
receiving from an optical fiber an optical signal converted from a first mixed output from a source device, the first mixed output comprising a video signal and an audio signal;
converting the optical signal to a second mixed output comprising a video signal and an audio signal; and
outputting a result of conversion to a sink device.
